(19) United States
(12) Patent Application Publication
(10) Pub. No.: US 2026/0152116 A1
(43) Pub. Date: Jun. 4, 2026

(54) SYSTEMS AND METHODS OF INCREASING UNDERSTANDING OF AN AUTONOMOUS VEHICLE FROM TYPICAL ROAD USERS

(71) Applicant: Torc Robotics, Inc., Blacksburg, VA (US)

(72) Inventor: Rasika Kangutkar, Austin, TX (US)

(21) Appl. No.: 18/965,145

(22) Filed: Dec. 2, 2024

(51) Int. Cl. B60Q 1/50

(52) U.S. Cl. CPC B60Q 1/5037; B60Q 1/507; B60Q 1/543; B60Q 1/545; B60Q 2800/10

(57) ABSTRACT

An autonomous vehicle for increasing understanding of the autonomous vehicle from typical road users is provided. The autonomous vehicle includes at least one sensor, a road user communication subsystem including at least one display, the at least one display positioned on an exterior of an autonomous vehicle, and an autonomy computing system. The at least one processor of the autonomy system is programmed to detect lanes and objects in an environment in which the autonomous vehicle is operating, based on sensor data received from the at least one sensor. The at least one processor is further programmed to classify the objects into corresponding classes, generate a traffic map depicting the objects in the corresponding classes and in corresponding lanes, and display the traffic map on the at least one display.

### TECHNICAL FIELD

The field of disclosure relates generally to autonomous vehicles and, more specifically, to object systems and methods for increasing understanding of the autonomous vehicle from typical road users.

### BACKGROUND OF THE INVENTION

Autonomous vehicles operate with limited human input such that typical road users may not fully trust the behavior of autonomous vehicles or may lack understanding of the operation and/or status of autonomous vehicles. For example, when a typical road user wishes to pass by an autonomous vehicle, the typical road user may feel apprehensive as the typical road user is uncertain whether the autonomous vehicle is able to “see” the typical road user to ensure a safe pass by the typical road user. The lack of understanding results in a less favorable view of autonomous vehicles and an increased chance for unsafe travel conditions for the autonomous vehicle and typical road users. Accordingly, systems and methods for increasing understanding of an autonomous vehicle from typical road users is desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomous vehicle for increasing understanding of the autonomous vehicle from typical road users is provided. The autonomous vehicle includes at least one sensor, a road user communication subsystem including at least one display, the at least one display positioned on an exterior of an autonomous vehicle, and an autonomy computing system. The autonomy computing system is in communication with the at least one sensor and the at least one display, the autonomy computing system including at least one processor in communication with at least one memory device. The at least one processor is programmed to detect lanes and objects in an environment in which the autonomous vehicle is operating, based on sensor data received from the at least one sensor. The at least one processor is further programmed to classify the objects into corresponding classes, generate a traffic map depicting the objects in the corresponding classes and in corresponding lanes, and display the traffic map and an intent of the autonomous vehicle on the at least one display.

In another aspect, a method for increasing understanding of an autonomous vehicle from typical road users is provided. The method includes detecting, by one or more processors of an autonomy system of an autonomous vehicle in communication with at least one sensor of the autonomous vehicle, lanes and objects in an environment in which the autonomous vehicle is operating, based on sensor data received from the at least one sensor. The method also includes classifying, by the one or more processors, the objects into corresponding classes. The method further includes generating, by the one or more processors, a traffic map depicting the objects in the corresponding classes and corresponding lanes. In addition, the method includes displaying the traffic map on a road user communication subsystem including at least one display, the at least one display positioned on an exterior of the autonomous vehicle.

In yet another aspect, one or more non-transitory computer readable media for increasing understanding of an autonomous vehicle from typical road users is provided. The one or more non-transitory computer readable media includes a plurality of instructions stored that, in response to being executed, cause a system to detect lanes and objects in an environment in which an autonomous vehicle is operating, based on sensor data received from at least one sensor, and classify the objects into corresponding classes. The one or more non-transitory computer readable media further cause the system to generate a traffic map depicting the objects in the corresponding classes and the corresponding lanes, and display the traffic map on at least one display.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a schematic diagram of an autonomous vehicle 100 in a roadway 300.

FIG. 4 is a flow chart of an example method of increasing understanding of an autonomous vehicle and typical road users.

FIG. 5 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods of improving understanding between an autonomous vehicle and typical road user are provided. The success of autonomous vehicles traveling on the road relies at least in part on the trust and understanding between typical road users and the autonomous vehicle. As a new user of the road, autonomous vehicles have aspects distinguished from typical human road users. For example, typical road users are not sure what and whether an autonomous vehicle can “see” in its surroundings for the typical road users to make decisions and/or take actions accordingly. In at least some known methods, the autonomous vehicle displays the intent of the autonomous vehicle without communicating the relevance of the intent to other typical road users.

In contrast, the systems and methods described herein address the above-described problems in known methods to improve trust between an autonomous vehicle and typical road users. The systems and methods described herein include a road user communication subsystem that communicates the perception by the autonomous vehicle and the perception in relation with other typical road users and the autonomous vehicle, thereby increasing understanding of the autonomous vehicle from the typical road users. The road user communication subsystem may also communicate the status and/or states of the autonomous vehicle, thereby increasing safety on the road and further increasing trust with the autonomous vehicle. In some embodiments, to further increase the trust, the road user communication subsystem provides communication regarding traffic information that is occluded from typical road users by the autonomous vehicle.

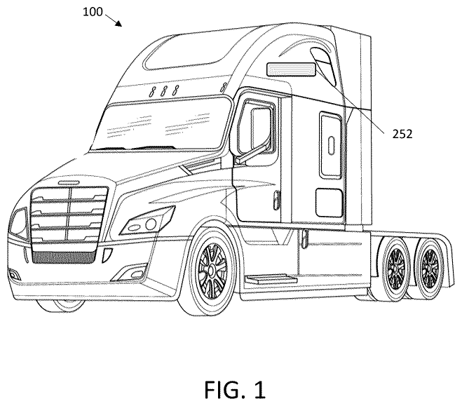

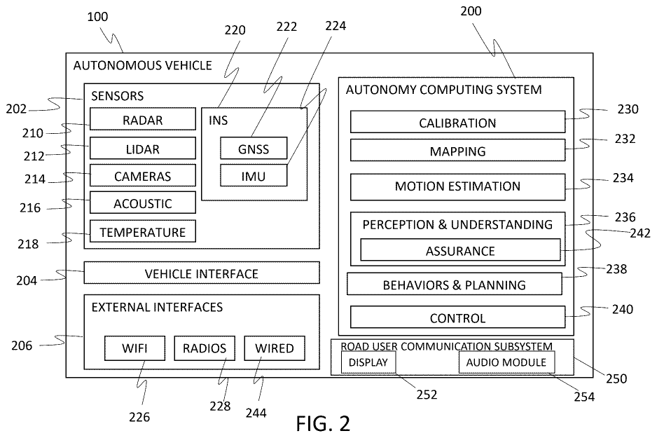

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, external interfaces 206 and a road user communication subsystem 250.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, road user communication subsystem 250 includes one or more displays 252 and audio module 254. Display 252 may be positioned on an exterior of autonomous vehicle 100. The road user communication subsystem 250 is configured to communicate to typical road users and pedestrians within an environment surrounding autonomous vehicle 100.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and assurance module 242. Assurance module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Assurance module 242 generates a traffic map based on classified objects, lanes, and events detected by perception and understanding module 236 in real time. As used herein, being real time refers to an action being performed without noticeable latency. Assurance module 242 receives, for example, positions of a vehicle from perception and understanding module 236 and generates a traffic map identifying the location of the vehicle in relation to autonomous vehicle 100.

Assurance module 242 is further configured to display the traffic map on at least one display 252 of road user communication subsystem 250 located on an exterior of the autonomous vehicle 100. For example, assurance module 242 causes the display of the traffic map on a display 252 identifying the location of a vehicle in relation to the autonomous vehicle 100.

Audio module 254 generates an audio notification based on classified objects, lanes, and events detected by perception and understanding module 236 in real time. Audio module 254, for example, is configured to cause one or more speakers inside display 252 and/or separate from display 252 on an exterior of the autonomous vehicle 100 to sonically communicate with typical road users or pedestrians.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

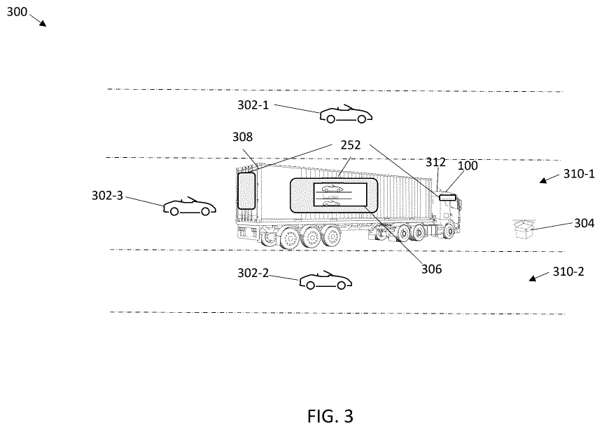

FIG. 3 is a schematic diagram of a roadway 300 including autonomous vehicle 100. Autonomous vehicles traveling in traffic is a relatively new phenomenon. Typical road users may be apprehensive of autonomous vehicles on the road due to the concerns of safety. Typical road users are unsure what and whether the autonomous vehicle can “see” in the traffic for the typical road users to adjust their driving behavior accordingly. A typical road user has learned a safety rule of thumb on the road that if the typical road user can see the driver of a vehicle, the driver can see the typical road user. An autonomous vehicle may not have a driver or an attentive driver, rendering the rule of thumb inapplicable. Further, typical road users may be uncertain about the states of the autonomous vehicle, how much the autonomous vehicle is aware of the states, and how well the autonomous vehicle responds to the states. For example, when a driver of the vehicle notices the engine light is on and has difficulties in accelerating the vehicle, the driver may turn on emergency lights to alert other typical road users while trying to move out of traffic. Systems and methods described herein provide a road user communication subsystem that is configured to communicate to typical road users of an autonomous vehicle's perception, states, intent, and actions in relation with the typical road users, to increase the trust of autonomous vehicles with other typical road users, thereby increasing safety on the road. To further increase the trust and safety, the communicated information may include information occluded from the typical road users.

In the example embodiments, the sensor data acquired by sensors 202 are processed by autonomy computing system 200 (see FIG. 2). Perception and understanding module 236 classifies objects surrounding the autonomous vehicle. For example, the classified objects may be a pedestrian or a vehicle. In another example, the perception and understanding module 236 may classify the objects surrounding the autonomous vehicle as other vehicles, bicycles, roadways, signage, traffic lights, or other objects in an environment surrounding the autonomous vehicle. In some embodiments, classification is performed by a machine learning model, where the machine learning model is configured to classify objects into classes and/or subclasses. To increase accuracy of classification, the machine learning model is trained with variations of objects in a class. For example, humans are in various body shapes and donned with various clothing or even costumes. The training data includes variations of objects in the class of person. Variations in objects of other classes, such as vehicles and cyclists, are also included in the training data.

In the example embodiments, redundancy in sensors is provided in autonomous vehicle 100. More than one sensor of a modality and/or more than one modality of sensors are provided. Redundancy provides backup sensor data in situations when a sensor and/or a modality of sensors malfunction. Redundancy also facilitates confirmation of classification via one senor and/or one modality of sensors by classification via another sensor and/or another modality of sensors.

In the example embodiments, the perception and understanding module 236 may also detect traffic events based on sensor data acquired by sensors 202. Traffic events are events in the traffic that may affect the driving decisions and/or behaviors of a typical road user. Traffic events include traffic stoppages, road work, obstacles, accidents and/or other traffic events.

In the example embodiments, assurance module 242 (see FIG. 2) is configured to generate a traffic map 306 in real time of an environment surrounding autonomous vehicle 100 based on the sensor data. Traffic map 306 may be updated in real time. Traffic map 306 includes classified objects, lanes, and/or events detected by perception and understanding module 236. Traffic map 306 depicts the objects in the corresponding classes and in corresponding lanes 310. For example, traffic map 306 includes objects such as vehicles 302, autonomous vehicle 100, and lanes 310. The vehicles may have subclasses, such as passenger vehicles, a truck, or a semi-truck. In traffic map 306, the objects are depicted in their corresponding classes and/or subclasses in the corresponding lanes which the objects are traveling along or positioned in. Autonomous vehicle 100 is also depicted in traffic map 306 in its corresponding lane along which the autonomous vehicle is travelling.

In the example embodiments, with traffic maps 306, typical road users are provided with information perceived by autonomous vehicle 100. Based on whether typical road user 302 is or is not present on traffic maps 306, typical road user 302 may take action accordingly. For example, vehicle 302-1 is overtaking autonomous vehicle 100. If traffic map 306 shows vehicle 302-1 in the traffic map, the driver of vehicle 302-1 overtakes autonomous vehicle 100 with relative ease. If traffic maps 306 do not show vehicle 302-1, the driver of vehicle 302-1 notices the absence and takes extra care in overtaking autonomous vehicle 100.

Typical road users have learned to take extra care in driving next to another vehicle in the blind spot of that vehicle. In the example embodiment, road user communication subsystem 250 is configured to display a blind spot associated with autonomous vehicle in the adjacent lane on display 252. As used herein, a blind spot refers to a blind spot associated with an autonomous vehicle by considering the autonomous vehicle as a typical vehicle, where the blind spot is an area around the vehicle not easily visible to the driver of the vehicle. Blind spots may not exist in autonomous vehicle 100, where sensors 202 provide 360° of FOV of the environment. Accordingly, when a driver of a vehicle 302 believes vehicle 302 is travelling in the blind spot associated with autonomous vehicle 100, if display 252 shows vehicle 302 in the blind spot, the driver may drive with a relative ease, while if display 252 does not show vehicle 302 in the blind spot, the driver may speed up or slow down to move out of the blind spot. The display of the blind spot may be in traffic map 306 and/or in a separate part of display 252 from traffic map 306.

In the example embodiment, road user communication subsystem 250 is configured to show information on an autonomous vehicle state that indicates an intent of autonomous vehicle 100. For example, the intent includes turning, accelerating, or stopping of the autonomous vehicle 100. Communicating intent is helpful to typical road users in decision making. The intent is displayed with traffic map 306 on display 252. In some embodiments, the intent is displayed on a separate display 252 from display 252 for traffic map 306. In one example, a road user, such as a pedestrian and/or a cyclist, is waiting to cross a street when autonomous vehicle is approaching the crosswalk. One or more displays 252 illustrating traffic map 306 showing the traffic with the road user and autonomous vehicle 100 therein and intent of autonomous vehicle 100 help the road user to cross the street based on the intent or the intended actions of autonomous vehicle 100, thereby increasing safety on the road. In another example, errors may occur in detection and/or perception of the environment by autonomous vehicle 100, such as incorrect detection of an open adjacent lane. When the intent, such as an intent to merge into the adjacent lane, is displayed on display 252, the road users in the adjacent lane are provided with notice of the intent and extra time to adjust the driving decisions accordingly, thereby increasing safety of the road.

In the example embodiment, road user communication subsystem 250 is configured to communicate to typical road users traffic events occluded from other typical road users, thereby increasing safety on the road. For example, autonomous vehicle 100 detects an obstacle 304 ahead of autonomous vehicle 100. Obstacle 304 is occluded from vehicle 302-3 that is travelling behind autonomous vehicle 100. Road user communication subsystem 250 is configured to show obstacle 304 on display 252 positioned on the rear of a trailer 308 coupled with autonomous vehicle 100 or on the rear of a cabin 312 of autonomous vehicle 100 if autonomous vehicle 100 is not coupled with trailer 308. Showing obstacle 304 on display 252 provides notice to the driver of vehicle 302-3 of obstacle 304, increasing time for the driver of vehicle 302-3 to react. In one example, an intent is also displayed with traffic map 306 on one or more displays 252. Showing an intent and obstacle 304 on one or more displays 252 provides additional notice and time to the driver of vehicle 302-3, facilitating the driver of vehicle 302-3 to adjust the driving decision accordingly. In another example, autonomous vehicle 100 detects the lane 310 along which autonomous vehicle 100 is travelling is closing or blocked. The information is communicated to typical road users via road user communication subsystem 250.

In the example embodiments, display 252 includes an autonomous vehicle state. The vehicle state may include a malfunction of autonomous vehicle 100. A malfunction, for example, includes non-operable tires, damaged headlights, or non-functioning windshield wipers. In some embodiments, the vehicle state includes information about autonomous vehicle 100. For example, the information may include a destination of the autonomous vehicle 100.

In the example embodiments, road user communication subsystem 250 is configured to provide a warning notification. For example, a warning notification may be included in display 252 when the autonomous vehicle 100 is in a first lane 310-1 and autonomy computing system 200 detects a second vehicle 302-2 in a second lane 310-2 crossing into first lane 310-1. In another example, a warning notification may be included in display 252 when a second vehicle 302-2 adjacent to autonomous vehicle 100 moves too closely to autonomous vehicle while the autonomous vehicle is in a drive mode, e.g., for example, less than 0.5 meter.

In example embodiments, assurance module 242 is configured to cause display of traffic map 306 on at least one display 252 of road user communication subsystem 250 located on the exterior of autonomous vehicle 100. Based on traffic map 306 of the environment surrounding autonomous vehicle 100, assurance module 242 may cause one display to display a different portion of traffic map 306 than another display. For example, if vehicle 302-1 is located in a lane left of the autonomous vehicle 100 and vehicle 302-2 in a lane right of autonomous vehicle 100, a first display, facing vehicle 302-1, may display vehicle 302-1 and a second display, facing vehicle 302-2, may display vehicle 302-2.

In example embodiments, audio module 254 is configured to provide audio communication based on traffic map 306. For example, audio module 254 causes a speaker located inside at least one display 252 and/or separate from display 252 to sonically communicate to vehicle 302-3 when autonomous vehicle 100 detects obstacle 304.

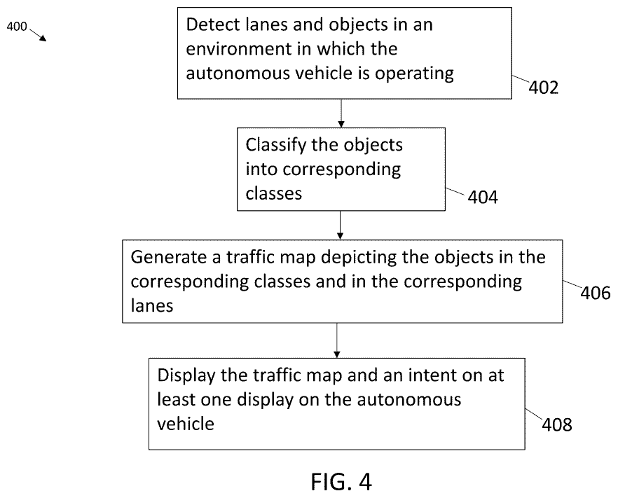

FIG. 4 is a flow chart of an example method 400 of increasing understanding between an autonomous vehicle and a typical road user. Method 400 may be implemented by autonomy computing system 200 of autonomous vehicle 100. In the example embodiment, method 400 includes detecting 402 lanes and objects in an environment in which the autonomous vehicle is operating. Method 400 also includes classifying 404 the objects into corresponding classes. Method 400 further includes generating 406 a traffic map depicting the objects in the corresponding classes and corresponding lanes. In the depicted embodiment, method 400 includes displaying 408 the traffic map and an intent of the autonomous vehicle 100 on at least one display on the autonomous vehicle 100. In some embodiments, only the traffic map is shown on the at least one display. In other embodiments, only intent is shown on the at least one display. Road users adjust driving decisions based on the traffic map and/or the intent.

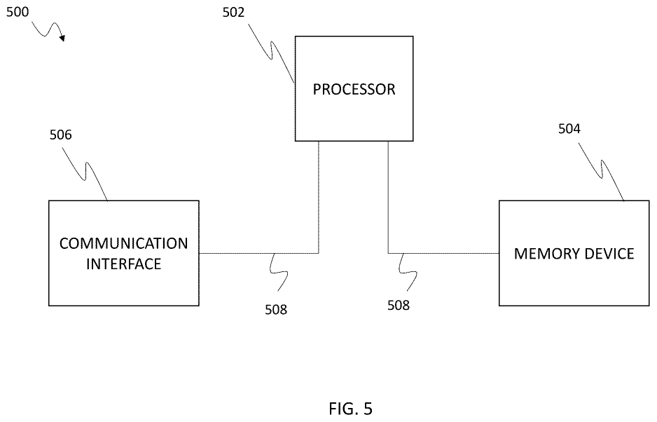

FIG. 5 is a block diagram of an example computing device 500. Autonomy computing system 200 may be implemented with one or more computing devices 500. Computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing - either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) increasing understanding between an autonomous vehicle and typical road users, (b) generating a traffic map, or (c) communicating the traffic map with a typical road users or pedestrians.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomous vehicle for increasing understanding of the autonomous vehicle from typical road users, the autonomous vehicle comprising:
at least one sensor;
a road user communication subsystem comprising at least one display positioned on an exterior of the autonomous vehicle;
an autonomy computing system in communication with the at least one sensor and the road user communication subsystem, the autonomy computing system comprising at least one processor in communication with at least one memory device, the at least one processor programmed to:
detect lanes and objects in an environment in which the autonomous vehicle is operating, based on sensor data received from the at least one sensor;
classify the objects into corresponding classes;
generate a traffic map depicting the objects in the corresponding classes and in corresponding lanes; and
display the traffic map and an intent of the autonomous vehicle on the at least one display.

2. The autonomous vehicle of claim 1, wherein the at least one processor further programmed to:
detect traffic events in the environment, the traffic events occluded from other typical road users by the autonomous vehicle; and
display the traffic events on the at least one display.

3. The autonomous vehicle of claim 1, wherein the at least one processor is further programmed to:
determine a malfunction of the autonomous vehicle; and
display the malfunction on the at least one display.

4. The autonomous vehicle of claim 1, wherein the at least one display is positioned facing an adjacent lane, the at least one processor further programmed to:
display a blind spot associated with the autonomous vehicle on the at least one display.

5. The autonomous vehicle of claim 1, wherein the at least one processor is further programmed to:
determine at least one pedestrian in traffic when the autonomous vehicle is approaching a crosswalk; and
signal to the at least one pedestrian an intent related to the at least one pedestrian.

6. The autonomous vehicle of claim 1, wherein the at least one processor is further programmed to:
communicate, via the road user communication subsystem, states of the autonomous vehicle to the typical road users.

7. The autonomous vehicle of claim 1, wherein the road user communication subsystem comprises an audio module configured to sonically communicate with the typical road users.

8. The autonomous vehicle of claim 1, wherein the at least one processor is further programmed to:
classify, using a machine learning model, the objects into corresponding classes, wherein the machine learning model is trained with variations of objects in a class.

9. The autonomous vehicle of claim 1, wherein the autonomous vehicle comprises at least one of redundant sensors or redundant modalities of sensors.

10. A method for increasing understanding of an autonomous vehicle from typical road users, the method comprising:
detecting, by one or more processors of an autonomy system of the autonomous vehicle in communication with at least one sensor of the autonomous vehicle, lanes and objects in an environment in which the autonomous vehicle is operating, based on sensor data received from the at least one sensor, the autonomous vehicle further including a road user communication subsystem including at least one display positioned on an exterior of the autonomous vehicle;
classifying, by the one or more processors, the objects into corresponding classes;
generating, by the one or more processors, a traffic map depicting the objects in the corresponding classes and in corresponding lanes; and
displaying the traffic map on the at least one display.

11. The method of claim 10, wherein:
generating the traffic map further comprises detecting, by the one or more processors, traffic events in the environment, the traffic events occluded from other typical road users by the autonomous vehicle; and
displaying the traffic map further comprises displaying, on the at least one display, the traffic events.

12. The method of claim 10, wherein:
generating the traffic map further comprises determining, by the one or more processors, a malfunction of the autonomous vehicle; and
displaying the traffic map further comprises displaying the malfunction on the at least one display.

13. The method of claim 10, wherein displaying the traffic map further comprises displaying, on the at least one display, a blind spot associated with the autonomous vehicle, wherein the at least one display is positioned facing an adjacent lane.

14. The method of claim 10, wherein generating the traffic map further comprises determining, by the one or more processors, at least one pedestrian in traffic when the autonomous vehicle is approaching a crosswalk, and the method further comprises signaling to the at least one pedestrian an intent related to the at least one pedestrian.

15. The method of claim 10 further comprising communicating, via the road user communication subsystem, states of the autonomous vehicle to the typical road users, wherein the road user communication subsystem includes an audio module configured to sonically communicate with the typical road users.

16. The method of claim 10 further comprising classifying, using a machine learning model, the objects into corresponding classes, wherein the machine learning model is trained with variations of objects in a class.

17. One or more non-transitory computer readable media for increasing understanding of an autonomous vehicle from typical road users, the one or more non-transitory computer readable media comprising a plurality of instructions stored thereon that, in response to being executed, cause a system to:
detect lanes and objects in an environment in which an autonomous vehicle is operating, based on sensor data received from at least one sensor of the autonomous vehicle;
classify the objects into corresponding classes;
generate a traffic map depicting the objects in the corresponding classes and corresponding lanes; and
display the traffic map on at least one display of the autonomous vehicle.

18. The one or more non-transitory computer readable media of claim 17, wherein the plurality of instructions further cause the system to:
detect traffic events occurred in the environment, the traffic events occluded from other typical road users by the autonomous vehicle; and
display the traffic events on the at least one display.

19. The one or more computer readable media of claim 17, wherein the plurality of instructions further cause the system to:
determine a malfunction of the autonomous vehicle; and
display the malfunction on the at least one display.

20. The one or more computer readable media of claim 17, wherein the plurality of instructions further cause the system to:
detect, via the at least one sensor of the autonomous vehicle, a blind spot associated with the autonomous vehicle; and
display the blind spot on the at least one display positioned facing an adjacent lane.
